(19) United States
(12) Patent Application Publication
(10) Pub. No.: US 2004/0021376 A1
(43) Pub. Date: Feb. 5, 2004

(54) Converter for electrical machines

(76) Inventor: Klaus Beulich, Sachsenheim (DE)

Correspondence Address: Striker Striker & Stenby, 103 East Neck Road, Huntington, NY, 11743, US

(21) Appl. No.: 10/333,086

(22) PCT Filed: May 15, 2002
(86) PCT No.: PCT/DE02/01736

(30) Foreign Application Priority Data
May 15, 2002 (DE) 101 23 626.3

(51) Int. Cl. H02K 9/00

(52) U.S. Cl. 310/52

(57) ABSTRACT

The converter comprises a plurality of bridge circuits (1, 2, 3, . . . . , n), connected to phase windings (4, 5, 6, 7) of a machine, of which each circuit has a plurality of electrically controllable switches (11, 12, 21, 22, 31, 32, . . . , n1, n2) and one buffer memory embodied as a capacitor (15).

A version of the converter that is simple from a production standpoint and is highly economical in terms of space is obtained by providing that the capacitor (15) is embodied as a foil capacitor surrounding the machine, to the electrodes (16, 17) of which the bridge circuits (1, 2, 3, n) are connected, distributed over the circumference of the machine.

### PRIOR ART

The present invention relates to a converter for electric machines, in particular for starters or starter-generators in motor vehicles, in which the converter comprises a plurality of bridge circuits connected to phase windings of the machine, of which circuits each has a plurality of electrically controllable switches and one buffer memory, embodied as a capacitor.

One such converter is known from German Patent Disclosure DE 199 47 476 A1. With a converter, used for instance to adjust the rpm of an electric machine, a periodic activation and deactivation of the individual phase windings of the machine is generated via a pulse width modulated triggering of the switches in the bridge circuits connected to the phase windings. As a result of these switching events, relatively high interference voltage peaks occur, which are smoothed by means of a buffer memory embodied as a capacitor. Because of the very high interference voltage peaks, the capacitors of the bridge circuits must have a relatively high capacitance. For the buffer memory, an electrolyte capacitor is therefore used as a rule, since electrolyte capacitors have an especially high capacitance. However, electrolyte capacitors have a relatively large volume, and at high temperatures they tend to fail early. In order to be capable of dispensing with such capacitors of very high capacitance, in DE 199 47 476 A1 an otherwise three-phase machine is operated with many phases (that is, more than three phases). To that end, the converter has not merely three bridge circuits (as in a three-phase machine) but rather many bridge circuits, which are triggered at staggered times relative to one another. Each of these bridge circuits is connected to one phase winding of the machine. In this many-phase arrangement, the clock frequency of the pulse width modulated triggering of the switches of the individual bridge circuits is increased. Since the requisite capacitance of the capacitors belonging to the individual bridge circuits depends on the clock frequency of the pulse width modulation, at a higher clock frequency the requisite capacitance is reduced compared to an only three-phase system. A multi-phase operation of the machine accordingly makes it possible to use capacitors of lesser capacitance for the bridge circuits, and therefore a changeover can be made from the electrolyte capacitors typically used to other capacitor principles. Simple foil capacitors, whose capacitance is comparatively low and which can be produced less expensively, can therefore be used. Moreover, foil capacitors do not heat up as much and are therefore also suited for use at high ambient temperatures, of the kind that occur in motor vehicles, for instance.

As taught by DE 199 47 476 A1, the bridge circuits that accomplish the multi-phase nature of the machine are embodied as modules, which are distributed over the machine circumference. The individual bridge modules comprise at least one high-side switch and at least one low-side switch and one capacitor, spanning the two switches, embodied as a concentrated component. The high-side switch connects the phase winding of the machine that is connected to the respective bridge circuit to a positive potential of a supply voltage, and the low-side switch makes the connection of the phase winding with a negative potential of the supply voltage.

### ADVANTAGES OF THE INVENTION

According to the characteristics of claim 1, a simplification in terms of production of a converter of the type defined at the outset is attained by providing that a foil capacitor surrounding the machine is present, to whose electrodes the bridge circuits are connected, distributed over the circumference of the machine. Thus the concentrated capacitors used in each bridge circuit in the prior art are dispensed with and are replaced with a space-saving foil capacitor that is simple to produce and that serves as the capacitance, forming the buffer memory, for all the bridge circuits that are present.

Advantageous refinements of the invention are recited in the dependent claims.

It is expedient that the foil capacitor and the switches, contacted with it, of the bridge circuits are fixed jointly on a heat sink surrounding the machine. The foil capacitor and the switches of the bridge circuits can be fixed side by side on the cylindrical surface of the heat sink. However, the foil capacitor can also be fixed on the cylindrical surface of the heat sink, and the switches of the bridge circuits can also be fixed on an end face, oriented perpendicular to the cylindrical surface, of the heat sink. In the same way, the foil capacitor and the switches of the bridge circuits can be disposed in two planes one above the other on the cylindrical surface of the heat sink. The heat-generating switches should be located in the plane closest to the heat sink.

An optimal dissipation of the heat generated by the machine and by the switches and the foil capacitor can be attained by providing that in the interior of the heat sink, one or more conduits for the flow therethrough of a coolant are provided.

### DRAWING

The invention will be described in further detail below in terms of several exemplary embodiments shown in the drawing. Shown are:

FIG. 1, a circuit diagram of a converter with a plurality of bridge circuits;

FIG. 2, a cross section through a machine, with a foil capacitor wrapped around the machine;

FIG. 3, a foil capacitor and switches of bridge circuits that are disposed side by side on a heat sink of a machine;

FIG. 4, a foil capacitor and switches of bridge circuits that are disposed on various sides of a heat sink of a machine; and

FIG. 5, a foil capacitor and switches of a bridge circuit that are disposed in various planes on a heat sink of a machine.

### DESCRIPTION OF EXEMPLARY EMBODIMENTS

In FIG. 1, the circuit diagram is shown for a converter that is designed for multi-phase operation of an electric machine that is otherwise designed for three-phase operation. This converter comprises n bridge circuits 1, 2, 3, . . . , n. The number n of bridge circuits depends on the number k of chronologically staggered pulses with which the phase windings of the electric machine are to be triggered. For an intrinsically three-phase machine, the number n of bridge circuits required is then n=3* k.

Each of the bridge circuits 1, 2, 3, . . . , n comprises the series circuit of two electrically controllable switches. The bridge circuit 1 has the switches 11, 12; the bridge circuit 2 has the switches 21, 22; the bridge circuit 3 has the switches 31, 32; and the bridge circuit n has the switches n1, n2. A phase winding of the electric machine is connected to a tap between the two switches of each bridge circuit. Thus the phase winding 4 is connected to the bridge circuit 1, the phase winding 5 is connected to the bridge circuit 2, the phase winding 6 is connected to the bridge circuit 3, and the phase winding 7 is connected to the bridge circuit n. The switches 11, 21, 31, . . . , n1 in the individual bridge circuits are high-side switches, by way of which the associated phase winding 4, 5, 6, 7 can be connected to a positive potential of a supply voltage, and the second switch 12, 22, 32, . . . , n2 of the individual bridge circuits is a low-side switch, by way of which the associated phase winding 4, 5, 6, 7 can be connected to a negative potential of the supply voltage.

A pulse-width-modulated triggering with chronologically staggered pulses of the individual switches 11, 12, 21, 22, 31, 32, . . . , n, n2 is provided by a control circuit 8. The control circuit 8 in FIG. 1 therefore has one terminal 13, 14, 23, 24, 33, 34, . . . , n3, n4 for each control input of the existing switches.

A buffer memory in the form of a capacitance is connected parallel to the two switches 11, 12, 21, 22, 31, 32, . . . , n1, n2 of each bridge circuit 1, 2, 3, . . . , n. This capacitance is a capacitor 15, which is embodied as an elongated foil capacitor, and to whose two electrodes 16, 17 the switches are connected, distributed over the length of the foil capacitor 15. One foil capacitor 15 suffices as the buffer memory for all the bridge circuits 1, 2, 3, . . . , n, because on account of the multi-phase mode of operation, only slight voltage peaks that have to be smoothed by the capacitor 15 occur. The electrode 17 of the capacitor 15 has a terminal 18 for the positive potential of a supply voltage, and the electrode 16 is provided with a terminal 19 for the negative potential of a supply voltage. If the electric machine is a starter or starter-generator for a vehicle, then this supply voltage comes from a battery in the vehicle.

A detailed description of the mode of operation of the converter will not be provided here, because the invention is directed more to the embodiments of the capacitor 15, and the circuit of the converter can have any embodiment, in accordance with the prior art and even differing from FIG. 1.

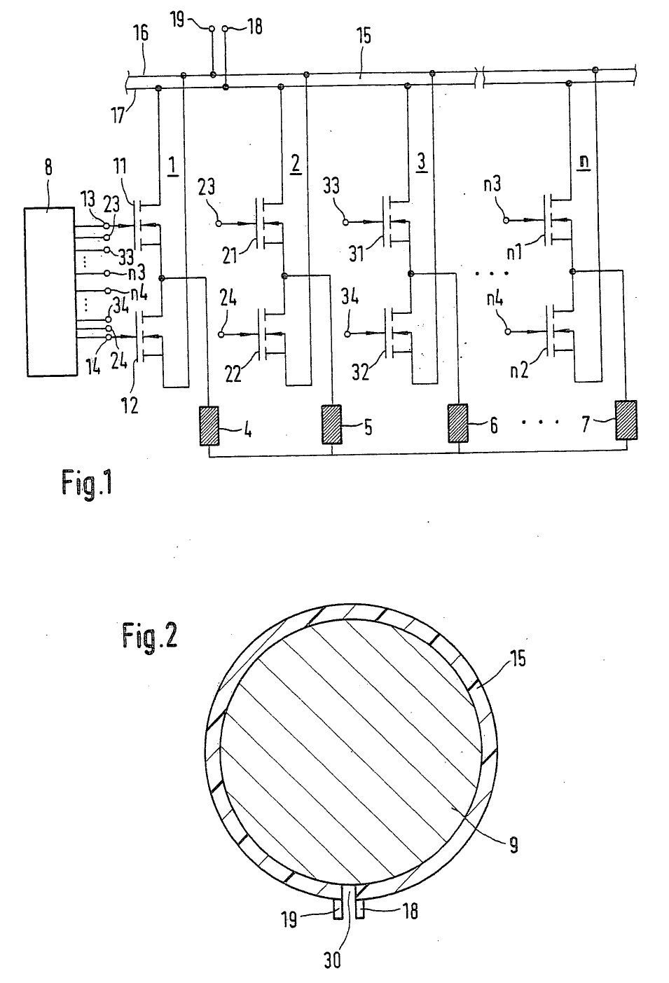

In FIG. 2, a cross section is schematically shown through an electric machine 9, which by way of example has a round cross section, as shown in FIG. 2. As already noted, the capacitor 15 is embodied as an elongated foil capacitor, which is wrapped around the circumference of the housing of the machine 9. In FIG. 2, the two electrode terminals 18 and 19, which can be connected to a supply voltage, of the foil capacitor 15 can be seen. From the standpoint of production, a foil capacitor 15 is simple to make. Because it is wrapped around the outer face of the housing of the machine 9, it claims only very little space. Different thermal expansion of the housing of the machine 9 compared to that of the foil capacitor 15 can be compensated for by means of a slit 30 in the foil capacitor 15.

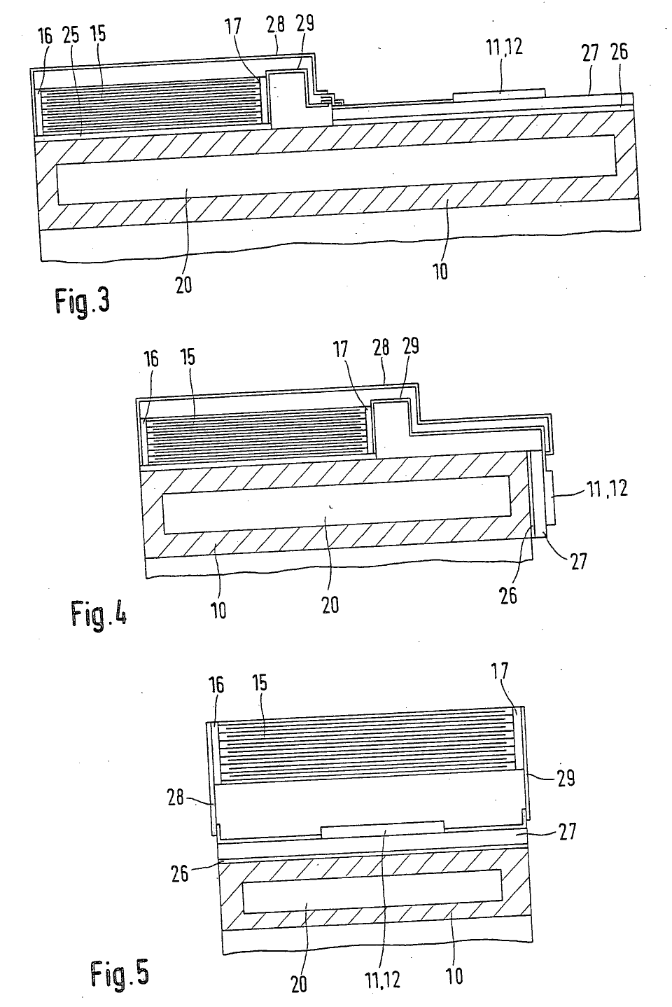

More detailed ways of disposing the foil capacitor 15, with the controllable switches of the bridge circuits, on the housing of the electric machine 9 are shown in FIGS. 3-5 described below.

In FIG. 3, a cross section of a detail through a cylindrical heat sink 10, which is either part of the housing of the machine 9 or surrounds the housing of the machine 9, is shown. This heat sink 10 can have one or more conduits 20 in its interior for the flow therethrough of a coolant (cooling gas or cooling liquid). The foil capacitor 15 is placed on the top of the heat sink 10 and fixed thereon, for instance by means of an adhesive film 25. Besides the foil capacitor 15, the modular bridge circuits are distributed over the circumference of the heat sink 10. The modules of the individual bridge circuits have a substrate, which is fixed to the surface of the heat sink 10 by means of an adhesive film 26. The switches belonging to the respective bridge circuit (in this case, the switches 11 and 12 of the bridge circuit 1 represent them all) are applied to the substrate 27 and electrically connected to the electrodes 18 and 19 of the foil capacitor 15 via busbars 28 and 29.

While in the exemplary embodiment in FIG. 3 the foil capacitor 15 and the modules of the bridge circuit are disposed side by side on a common surface of the heat sink 10, in the exemplary embodiment shown in FIG. 4 the foil capacitor 15 is fixed to the surface of the heat sink 10, while the modules of the bridge circuits are fixed to a face end of the heat sink 10. All the parts of the arrangement shown in FIG. 4 that have the same function as the elements shown in FIG. 3 have the same reference numerals and will not be described again here.

In the exemplary embodiment shown in FIG. 5 as well, the elements of the arrangement that have already been described above in conjunction with FIG. 3 are provided with the same reference numerals. In the exemplary embodiment of FIG. 5, the foil capacitor 15 and the modules of the bridge circuits (substrates 27 with switches 11, 12) are disposed in two planes one above the other on the surface of the heat sink 10. The modules of the bridge circuits are applied directly to the surface of the heat sink 10 in a first plane, and the foil capacitor 15 is located over them in a second plane. The foil capacitor 15 is held in the second plane by means of the busbars 28 and 29, which are contacted with the modules of the bridge circuits that are located under the foil capacitor 15.

1. A converter for electric machines, in particular for starters or starter-generators in motor vehicles, in which the converter comprises a plurality of bridge circuits (1, 2, 3, . . . , n) connected to phase windings (4, 5, 6, 7) of the machine, of which circuits each has a plurality of electrically controllable switches (11, 12, 21, 22, 31, 32, . . . , n, n2) and one buffer memory, embodied as a capacitor (15), characterized in that a foil capacitor (15) surrounding the machine (9) is present, to whose electrodes (16, 17) the bridge circuits (1, 2, 3, . . . , n) are connected, distributed over the circumference of the machine (9).

2. The converter of claim 1, characterized in that the foil capacitor (15) and the switches (11, 12), contacted with it, of the bridge circuits are fixed jointly on a heat sink (10) surrounding the machine.

3. The converter of claim 2, characterized in that the foil capacitor (15) and the switches (11, 12) of the bridge circuits are fixed side by side on the cylindrical surface of the heat sink (10).

4. The converter of claim 2, characterized in that the foil capacitor (15) is fixed on the cylindrical surface of the heat sink (10), and the switches (11, 12) of the bridge circuits are fixed on an end face, oriented perpendicular to the cylindrical surface, of the heat sink (10).

5. The converter of claim 2, characterized in that the foil capacitor (15) and the switches (11, 12) of the bridge circuits are disposed in two planes one above the other on the cylindrical surface of the heat sink (10), and the switches (11, 12) are disposed in the plane located closest to the heat sink (10).

6. The converter of one of claims 2-5, characterized in that the heat sink (10), in its interior, has one or more conduits (20) for the flow therethrough of a coolant.
